(19) United States
(12) Patent Application Publication
(10) Pub. No.: US 2024/0294553 A1
(43) Pub. Date: Sep. 5, 2024

(54) SIZE-SELECTIVE ACYCLIC CHELATORS AND THEIR USE FOR THE RECOVERY OF RARE EARTH ELEMENTS

(71) Applicant: UT-Battelle, LLC, Oak Ridge, TN (US)

(72) Inventors: Nikki Thiele, Oak Ridge, TN (US); Bruce A. Moyer, Oak Ridge, TN (US); Janel Dempsey, Oak Ridge, TN (US)

(21) Appl. No.: 18/443,585

(22) Filed: Feb. 16, 2024

Related U.S. Application Data
(60) Provisional application No. 63/446,371, filed on Feb. 17, 2023.

(51) Int. Cl. C07F 5/00; C22B 3/44; C22B 7/00; C22B 59/00

(52) U.S. Cl. CPC C07F 5/00; C22B 3/44; C22B 7/008; C22B 59/00

(57) ABSTRACT

A chelator having a composition including a compound having a chemical structure of formula (I) is provided, wherein X is a linking group selected from one of an ethyl, a propyl, a diethyl ether, a cyclohexyl, and a benzyl; each of R¹ and R² is a moiety including a terminal group selected from one of a carboxylic acid, a phosphinic acid, a phosphonic acid, a phenol, an amide, a carboxylic acid ester, a phosphinic acid ester, a phosphonic acid ester, and a phenol ether; and R³ and R⁴ are each selected from one of a hydroxy or an alkoxy group. A metal-ion complex including the chelator is also provided. Methods of separating a plurality of metals by size and recovering rare-earth elements by size are further provided.

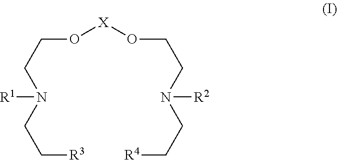

### CROSS-REFERENCE TO RELATED APPLICATIONS

This application claims the benefit of U.S. Provisional Application No. 63/446,371, filed Feb. 17, 2023, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to chelators, and more particularly chelators for separating metals and other applications.

### BACKGROUND OF THE INVENTION

Rare-earth elements (REEs) are essential to modern technology and are key components in many everyday devices such as household appliances, computers, phones, batteries, and water purifiers, to name a few. Rare-earth elements are also used for clean energy technologies such as wind turbines, electric vehicles, and fluorescent lighting. Nine REEs (La, Ce, Pr, Nd, Sm, Eu, Tb, Dy, and Y) are widely used in the permanent magnets, batteries, and phosphors that drive these technologies. The demand for REEs for use in these technologies is therefore understandably high. At the same time, while rare-earth elements are not in fact rare in their amounts found in the earth, they are not found in sufficient abundance in a single location. Thus, the efficient and economic recovery of REEs including the separation of REEs from mineral deposits is of clear importance.

Monazite ((Ce,La,Nd,Th)PO₄) is one such mineral that contains desirable rare-earth elements. One of the major commercial methods by which monazite is processed is alkali treatment. In this practice, monazite is cracked using hot, concentrated sodium hydroxide, resulting in the formation of RE/Th/U hydroxide and trisodium phosphate. After filtration to remove the soluble trisodium phosphate, the insoluble hydroxide cake is dissolved into solution using nitric, sulfuric, or hydrochloric acid. Because these strong acids possess no inherent selectivity for REEs, this leaching process results in mixed-element solutions. These mixtures must then undergo additional processing to isolate REEs from Th and U, typically culminating in hundreds of rounds of energy- and resource-intensive solvent extraction using organic extractants as a final step to separate the REEs based on their slight differences in ionic radius. As such, the current approach to monazite processing is inefficient, environmentally toxic, and expensive. Other rare-earth minerals such as xenotime, bastnäsite, and eudialyte are also important and pose separation challenges. Therefore, a need exists for more efficient and cost-effective methods for separating and recovering REEs from mineral sources such as these.

### SUMMARY OF THE INVENTION

Chelators are provided that have a composition including a compound having a chemical structure according to Formulas (I) through (V-k) herein. These chelators can selectively dissolve a targeted subset of REEs from mineral sources such as the hydroxide cake of cracked monazite, thereby introducing the element of precision REE separation into the leaching process. In another aspect, the chelators can serve as lixiviants that are leaching agents possessing the capacity for both molecular recognition and dissolution of REEs. These chelators can thermodynamically discriminate between large, light REEs (LREEs) and small, heavy REEs (HREEs), rendering possible the selective dissolution of LREEs into aqueous solution and the corresponding enrichment of HREEs in the solid phase. The chelators therefore provide for the efficient and cost-effective isolation of REEs from feed sources such as monazite, expanding the utility of monazite as a domestic source of critical REEs for use in clean energy technologies and other uses.

For example, in regards to the hydrometallurgical recovery of REEs from monazite, the chelators disclosed herein advantageously allow for the key step of REE separation to be implemented at the front-end of the process rather than the back-end. Selectively leaching targeted populations of REEs from cracked monazite using the chelators mitigates the need for downstream processing steps that typically involve swings in pH from one extreme to another to generate solutions suitable for solvent extraction. Hence, use of the chelators can reduce the consumption of corrosive acids and bases that are otherwise used in monazite processing methods, thereby rendering REE recovery more environmentally benign and economic. Furthermore, the chelators and accompanying separation methods using the chelators can decrease the reliance of REE separations on conventional countercurrent liquid-liquid extraction, which uses expensive mixer-settlers and generates large volumes of hazardous organic waste.

A metal-ion complex including a metal and the chelator is also provided. The chelator is a ligand coordinated with the metal.

In specific embodiments, the metal is a rare-earth metal.

In particular embodiments, the rare-earth metal is selected from lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), and yttrium (Y).

A method of separating a plurality of metals by size is also provided. The method includes using the chelator to separate the metals, wherein the chelator is reverse-size selective.

In specific embodiments, the separation is one of leaching, crystallization, or solvent extraction.

In specific embodiments, the plurality of metals are rare-earth metals.

In particular embodiments, the plurality of metals include two or more of lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), and yttrium (Y).

A method of recovering rare-earth elements by size is also provided. The method includes dissolving the chelator in a solvent to obtain a first solution. The method further includes adding a base to the first solution to obtain a second solution, wherein the base deprotonates the chelator compound. The method further includes introducing an insoluble rare-earth metal composition to the second solution to obtain a mixture, the rare-earth metal composition including a plurality of rare-earth metal components. The method further includes agitating the mixture for a period of time, wherein the compound is a leaching agent that forms a metal-ion complex with a component of the rare-earth metal composition based on size, the metal-ion complex being dissolved in the solvent whereby the compound dissolves the otherwise insoluble rare-earth metal component. The method further includes filtering the mixture to obtain a filtered solid and a supernatant, wherein the metal-ion complex is present in the supernatant.

In specific embodiments, the solvent is water.

In specific embodiments, the base is NaOH.

In specific embodiments, the method further includes the step of adding a buffer to second solution.

In specific embodiments, the pH of the solution is in a range of from 7 to 10.

In specific embodiments, the rare-earth metal composition includes a rare-earth metal hydroxide or rare-earth metal oxide.

In specific embodiments, the compound is size selective such that more large rare-earth elements (LREE) are present in the supernatant in comparison to small rare-earth elements (HREE).

In specific embodiments, the method further includes the step of disassociating the rare-earth element from the compound in the supernatant to strip the rare-earth element from the compound.

In particular embodiments, the step of disassociating the rare-earth element includes introducing oxalic acid to precipitate the rare-earth element as a rare-earth element oxalate, and subsequent filtration to separate the compound from the rare-earth element oxalate.

In certain embodiments, the method includes the step of adjusting the pH of the chelator compound.

These and other features of the invention will be more fully understood and appreciated by reference to the description of the embodiments and the drawings.

### BRIEF DESCRIPTION OF THE DRAWINGS

FIG. 1 is a schematic of chemical reaction steps for producing a chelator (“acyclopa”) in accordance with embodiments of the disclosure;

FIG. 2 is a schematic of chemical reaction steps for producing another chelator (“acyclopa-XL”) in accordance with embodiments of the disclosure;

FIG. 3 is a schematic of chemical reaction steps for producing a metal-ion complex in accordance with embodiments of the disclosure;

FIG. 4A is a side view of an X-ray crystal structure of [La(acyclopa)]CIO₄·DMF, in which ellipsoids are drawn at the 50% probability level, and hydrogen atoms attached to carbon centers, counteranions, and solvent molecules are omitted for clarity;

FIG. 4B is a top view of the X-ray crystal structure of FIG. 4A;

FIG. 5A is a side view of an X-ray crystal structure of [Y(acyclopa)]CIO₄·DMF, in which ellipsoids are drawn at the 50% probability level, and hydrogen atoms attached to carbon centers, counteranions, and solvent molecules are omitted for clarity;

FIG. 5B is a top view of the X-ray crystal structure of FIG. 5A;

FIG. 6 is a graph of stability constants (log K_{ML}) of acyclopa and solubility products (pKₛₚ) of RE(OH)₃ as a function of the 6-coordinate ionic radius of each RE³⁺ ion;

FIG. 7 is a graph of stability constants (log K_{ML}) of acyclopa as a function of the 6-coordinate ionic radius of each Ln³⁺ ion;

FIG. 8 is a graph of a comparison of stability constants (log K_{ML}) of acyclopa versus acyclopa-XL as a function of the 6-coordinate ionic radius of each Ln³⁺ ion;

FIG. 9 is a graph of the leaching of rare-earth elements from (La,Nd,Eu,Dy,Y)OH₃ by acyclopa as a function of pH;

FIG. 10 is a graph of the leaching of rare-earth elements from (La,Nd,Eu,Dy,Y)OH₃ by acyclopa as a function of solid loading;

FIG. 11 is a graph of the leaching of rare-earth elements from (La,Nd,Eu,Dy,Y)OH₃ by acyclopa versus ethylenediaminetetraacetic acid (EDTA);

FIG. 12 is a graph of the release of rare-earth elements (REE) from acyclopa and their subsequent precipitation as REE₂(C₂O₄)₃ as a function of pH and oxalic acid equivalents; and

FIG. 13 is a graph of the percent dissolution of La(OH)₃ at a pH of 8.2 using acyclopa through four leaching cycles.

### DETAILED DESCRIPTION OF THE CURRENT EMBODIMENTS

As discussed herein, the current embodiments relate to chelator compositions and their use in separating two or more metals by size. The chelator compositions include a compound having an acyclic scaffold structure and that is reverse size selective for larger metal ions over smaller metal ions. The compounds serve as ligands to form metal ion complexes with target metals in order to separate the target metals from a grouping of metal ions. In certain embodiments, the chelator compositions described herein enable precision leaching of rare earth elements (REEs) from their mineral ores by serving as Size-selective MoleculAr Recognition-Tailored (SMART) lixiviants. In one non-limiting exemplary aspect, the chelators provide for selectively extricating REEs from monazite feedstock [(Ce,La,Nd,Th)PO₄].

More particularly, in embodiments of the disclosure the chelator has a composition including a compound (i.e., molecule or ligand) having the following chemical structure denoted as Formula (I):

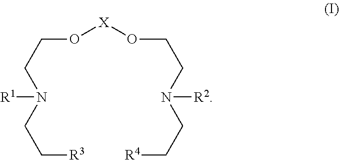

In Formula (I), X is a linking group that may be selected from one of an ethyl, a propyl, a diethyl ether, a cyclohexyl, and a benzyl group. The linking group X may further include alkyl groups having additional carbons, i.e. a longer carbon chain, such as a butyl group, a pentyl group, and so on, or an aryl group having more than one benzene ring. The linking group X may also include ether groups having longer carbon chains, such as but not limited to a dipropyl ether. The linking group is preferably unsubstituted, but is not limited to unsubstituted groups and may include substitution(s) at the carbons. The alkyl and/or acyclic linking groups are also preferably linear, but may also include branched hydrocarbon chains. The benzyl linking group may be connected in the ortho position, but is not necessarily limited to this configuration. Likewise, the cyclohexyl group may be connected at adjacent carbons, but is not necessarily so limited. The acyclic size of the chelator compound can be varied by varying the length of the linking group X, for example selecting between an ethyl group, a propyl group, and a diethyl ether. Similarly, the acyclic rigidity of the chelator compound can be varied by selecting between a linear (acyclic) linking group X such as an ethyl, a propyl, and a diethyl ether or a cyclic linking group X such as a cyclohexyl and a benzyl group, and the rigidity can be further tuned by selecting between a cyclohexyl group or a benzyl group.

In Formula (I), each of R¹ and R² is a moiety including a terminal group selected from one of a substituted or unsubstituted carboxylic acid (generally referred to herein as “a carboxylic acid”), a substituted or unsubstituted phosphinic acid (generally referred to herein as “a phosphinic acid”), a substituted or unsubstituted phosphonic acid (generally referred to herein as “a phosphonic acid”), a substituted or unsubstituted phenol (generally referred to herein as “a phenol”), a substituted or unsubstituted amide (generally referred to herein as “an amide”), a substituted or unsubstituted amine (generally referred to herein as “an amine”), a substituted or unsubstituted carboxylic acid ester (generally referred to herein as “a carboxylic acid ester”), a substituted or unsubstituted phosphinic acid ester (generally referred to herein as “a phosphinic acid ester”), a substituted or unsubstituted phosphonic acid ester (generally referred to herein as “a phosphonic acid ester”), and a substituted or unsubstituted phenol ether (generally referred to herein as “a phenol ether”), in their protonated forms. When deprotonated to form an ionic state of the chelator compound, the moieties/terminal groups become a carboxylate, a phosphinate, a phosphonate, a phenolate, and so on. The ester and ether variants of the terminal groups may be identical to the acid and phenol variants except that one or more of the (acidic) hydrogens of the hydroxyl group(s) is replaced with an alkyl group such as a methyl group, an ethyl group, a propyl group, and so on, whereby the hydroxyl group becomes a methoxy group, an ethoxy group, etc. By terminal group, it is meant that the group is at a terminal end of the structure of the R¹ and R² moieties. Further, it should be understood that the moieties forming R¹ and R² may be completely defined by the terminal groups (i.e., the moiety is the terminal group), or the moiety may include the terminal group connected to another group such as but not limited to a methyl group and/or a pyridine ring, for example a pyridine phosphinic acid, a pyridine amide, or a pyridine phenol fused ring structure. It should also be understood that the R¹ and R² moieties may include more than one terminal group, such as two carboxylic acid groups (i.e., a dicarboxylic acid). The R¹ and R² moieties form the pendant arms of the acyclic chelator compound structure. Preferably, R¹ and R² are the same (i.e., have an identical chemical structure), but alternatively R¹ and R² may be different moieties. In specific embodiments, R¹ and R² are each selected from one of the following moieties (IV-a) through (IV-k):

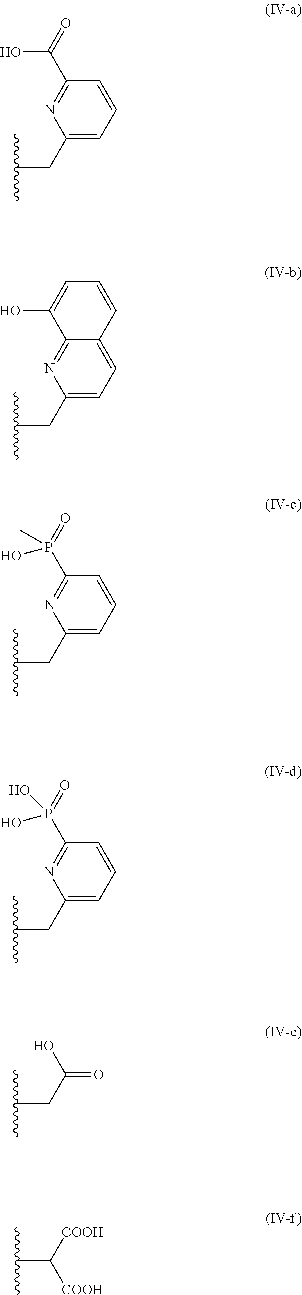 [SMILES: *Cc1cccc(C(=O)O)n1 ; *Cc1ccc2cccc(O)c2n1 ; *Cc1cccc(P(C)(=O)O)n1 ; *Cc1cccc(P(=O)(O)O)n1 ; *CC(=O)O ; *C(C(=O)O)C(=O)O]

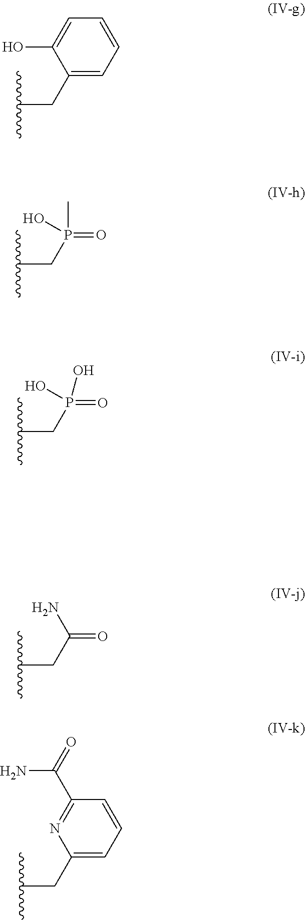

In certain embodiments, R¹ and R² are each a picolinic acid group (e.g., (IV-a)), which deprotonated is a picolinate group, i.e. a pyridyl carboxylate, the picolinic acid group including a methyl substituted at the 6-position of the pyridine ring, the methyl group forming the link between the moiety and nitrogen (N) in the acyclic scaffold shown in formula (I).

In Formula (I), each of R³ and R⁴ are each selected from one of a hydroxy (—OH) or an alkoxy group (—OR) wherein R is a hydrocarbon chain. The alkoxy group is preferably methoxy (—OCH₃), but may be an ethoxy (—OCH₂CH₃) or larger alkoxy having additional carbons. Further, R³ and R⁴ are preferably the same (i.e., have an identical chemical structure), but alternatively R³ and R⁴ may be different.

In one embodiment, the chelator compound has the following specific chemical structure denoted as Formula (II), having the chemical name 6,6′-(2,11-bis(2-hydroxyethyl)-5,8-dioxa-2,11-diazadodecane-1,12-diyl)dipicolinic acid, and which also may be referred to by the name “acyclopa”:

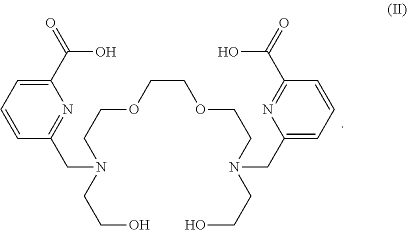

In Formula (II), X is an ethyl group, R¹ and R² are identical and both picolinic acid pendant arms connected to the nitrogen atoms of the acyclic scaffold structure by a carbon (methyl link) at the 6-position of the pyridine ring, and R³ and R⁴ are identical and both hydroxyl groups.

In another embodiment, the chelator compound has the following specific chemical structure denoted as Formula (III) and which also may be referred to by the name “acyclopa-XL”:

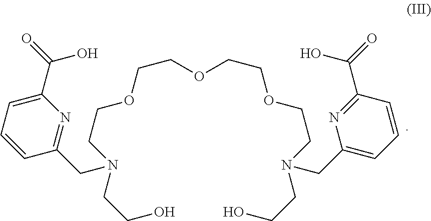

In Formula (III), X is a diethyl ether, R¹ and R² are identical and both picolinic acid pendant arms connected to the nitrogen atoms of the acyclic backbone structure by a carbon at the 6-position of the pyridine ring, and R³ and R⁴ are identical and both hydroxyl groups.

Other embodiments of exemplary chelator compounds have the following structures of Formulas (V-a) through (V-k):

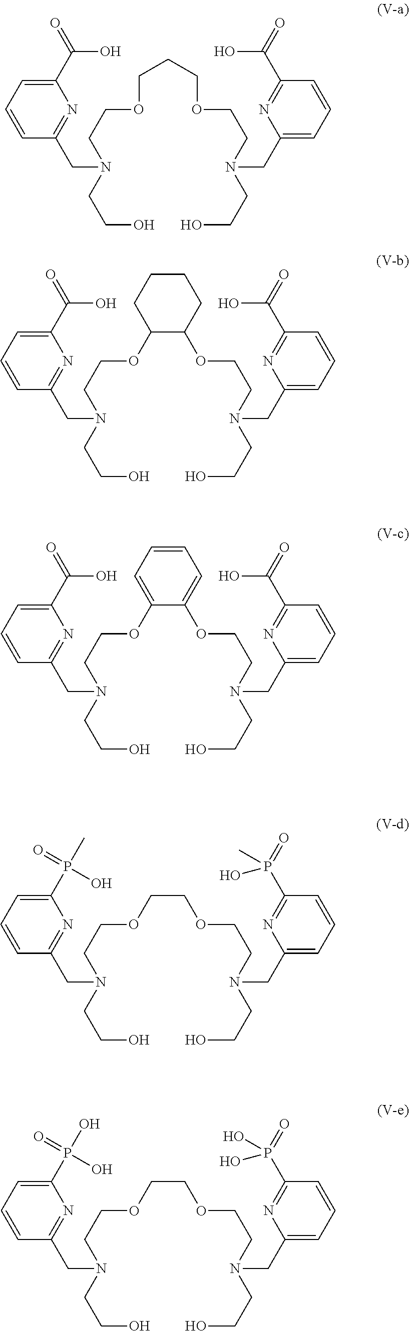 [SMILES: O=C(O)c1cccc(CN(CCO)CCOCCCOCCN(CCO)Cc2cccc(C(=O)O)n2)n1 ; O=C(O)c1cccc(CN(CCO)CCOC2CCCCC2OCCN(CCO)Cc2cccc(C(=O)O)n2)n1 ; O=C(O)c1cccc(CN(CCO)CCOc2ccccc2OCCN(CCO)Cc2cccc(C(=O)O)n2)n1 ; CP(=O)(O)c1cccc(CN(CCO)CCOCCOCCN(CCO)Cc2cccc(P(C)(=O)O)n2)n1 ; O=P(O)(O)c1cccc(CN(CCO)CCOCCOCCN(CCO)Cc2cccc(P(=O)(O)O)n2)n1]

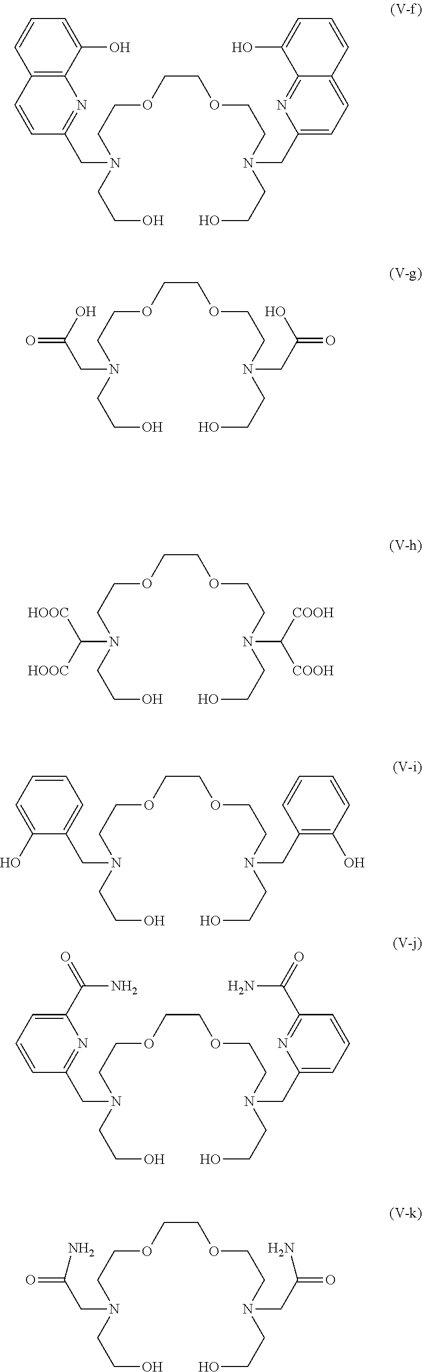 [SMILES: OCCN(CCOCCOCCN(CCO)Cc1ccc2cccc(O)c2n1)Cc1ccc2cccc(O)c2n1 ; O=C(O)CN(CCO)CCOCCOCCN(CCO)CC(=O)O ; O=C(O)C(C(=O)O)N(CCO)CCOCCOCCN(CCO)C(C(=O)O)C(=O)O ; OCCN(CCOCCOCCN(CCO)Cc1ccccc1O)Cc1ccccc1O ; NC(=O)c1cccc(CN(CCO)CCOCCOCCN(CCO)Cc2cccc(C(N)=O)n2)n1 ; NC(=O)CN(CCO)CCOCCOCCN(CCO)CC(N)=O]

In some embodiments, the chelator compound is a ligand bound to a metal/metal ion by coordinate bonding to form a metal-ion complex. The acyclic scaffold of the chelator provides sites for coordination to metal ions, and the two pendant arms of the chelator provide additional coordination sites. These additional donor atoms provide the ligand with enhanced affinity for REEs, which prefer coordination numbers ranging from 8 to 11. The metal/metal ion is not particularly limited, but in certain embodiments the metal/metal ion is a lanthanide rare-earth metal (i.e., a rare-earth element (REE), also known as one of the lanthanides or rare earths) selected from a group including lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), and yttrium (Y). In specific embodiments, the rare-earth metal is one of lanthanum (La), neodymium (Nd), europium (Eu), dysprosium (Dy), and yttrium (Y). The rare-earth metal also may be in the form of a rare-earth hydroxide or rare-earth oxide. An example of one chelator compound forming a metal-ion complex with a rare-earth metal is illustrated by the following chemical structure denoted as Formula (V):

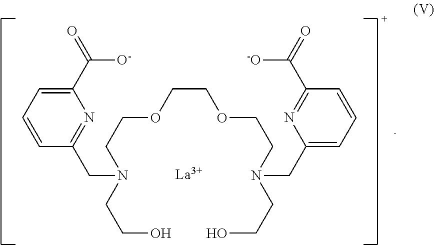

A method of synthesizing the chelators generally includes forming an acyclic scaffold such as 6,9-dioxa-3,12-diazatetradecane-1,14-diol from N-benzylethanolamine and a hydrocarbon linking two iodoethoxy groups such as 1,2-bis(2-iodoethoxy)ethane. The method also includes addition of pendant arms to the acyclic scaffold structure by introducing a brominated compound such as methyl 6-(bromomethyl)picolinate to the acyclic scaffold. Specific synthesis methods for the chelators are discussed in detail in the examples below. The methods of forming the acyclic chelators disclosed herein is advantageously simpler and less expensive than methods of forming macrocyclic chelators, making the acyclic chelators economically suitable for industrial processing of minerals including metals such as rare-earth elements, while at the same time maintaining size selectivity.

Methods of separating a group of two or more metals using the chelators disclosed herein are made possible by the unexpected size selectivity of the present acyclic chelators, particularly by the chelators being reverse-size selective. Reverse-size selective (and reverse-size selectivity) means that the chelator can thermodynamically discriminate between large, less charge dense (i.e., charge diffuse) metal ions and small, more charge dense metal ions such as large, light rare-earth elements (LREEs) over small, heavy rare-earth elements (HREEs). The LREEs are generally the rare earths having lower atomic numbers (i.e., 57 to 61) while the HREEs are generally the rare earths having higher atomic numbers (i.e., 62 and greater). Thus, the LREEs may be classified as lanthanum, cerium, praseodymium, neodymium, and promethium, while HREEs may be classified as samarium, europium, gadolinium, terbium, dysprosium, holmium, erbium, thulium, ytterbium, lutetium, scandium and yttrium, although samarium (62) and europium (63) alternatively may be included in the LREEs. Further, the atomic (and ionic) radii of the rare earths decrease with increasing atomic number (i.e., across the series), and as such the LREEs are larger than the HREEs. The chelators thereby have a greater affinity and selectivity for large metals/metal ions relative to small metals/metal ions, and dissolve larger rare-earth metals into solution (e.g., aqueous solution) while leaving smaller rare-earth metals in the solid phase. The size selectivity of the chelators is a surprising aspect in that the open, acyclic scaffold structure of Formula (I) is flexible/non-rigid (or at least less rigid than macrocyclic compounds) and would not be expected to maintain size selectivity. This selectivity bias is also synergistic with the solubility bias of rare-earth hydroxides, which is skewed towards large rare-earth hydroxides having enhanced solubility over small rare-earth hydroxides (solubility of RE hydroxides decreases across the lanthanide (Ln) series from the largest (lanthanum, log Kₛₚ=−21.7) to the smallest (lutetium, log Kₛₚ=−27.5)).

The separation may be either a leaching process, a crystallization process, or a solvent extraction process. The metals may be rare-earth elements including any grouping of lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), and yttrium (Y). In specific embodiments, the metals include two or more of lanthanum (La), lutetium (Lu), yttrium (Y), and scandium (Sc). Alternatively, the metals may be and/or include metals other than rare-earth elements, such as alkaline earth metals, i.e. beryllium (Be), magnesium (Mg), calcium (Ca), strontium (Sr), barium (Ba), and radium (Ra).

In some embodiments, the separation method is a leaching process to recover metal elements such as rare-earth elements by size. The method includes dissolving a chelator according to Formula (I) in a solvent, such as but not limited to water, to obtain a first solution. Next, a base such as sodium hydroxide (NaOH) is added to the first solution to obtain a second solution (the second solution differing from the first solution by the addition of the base). The base deprotonates the chelator compound to form a ligand. Depending on the composition of the metal-containing compound to be separated in the steps below (for example, if the compound is a metal hydroxide compound), it may not be necessary to add much if any base (e.g., sodium hydroxide). In any event, the pH of the solution may be adjusted throughout the separation to maintain the pH in a slightly basic range, for example a pH in the range of 7 to 10. Optionally, a buffer may be added to the second solution in order to maintain the pH of the second solution in a range of 7 to 10, optionally in a range of 8 to 10, optionally in a range of 8 to 9, optionally in a range of 8.2 to 9, optionally approximately 8.6. The buffer may be, for example, a CAPS or CHES buffer. A rare-earth metal composition is then introduced to the second solution to form a mixture. The rare-earth metal composition may be, for example, a rare-earth phosphate such as monazite ((Ce,La,Nd,Th)PO₄) and particularly monazite that has been cracked with sodium hydroxide to obtain an insoluble hydroxide cake of the metals. Alternatively, suitable metal compositions may be obtained from other sources that may or may not be phosphate minerals, such as xenotime (a rare-earth phosphate mineral), bastnäsite (a fluorocarbonate mineral), eudialyte, or coal ash, and may contain other elements such as uranium (U), thorium (Th), indium (In), and gallium (Ga). Suitable metal compositions may also be obtained from other minerals or mineral ores. Further, in other alternatives the metals may be present in the form of metal oxides; thus, the metals may be provided as or processed to obtain metal hydroxides and/or metal oxides. Absent the chelator, the rare-earth metal composition and its components are otherwise insoluble (completely or nearly completely) in the solvent. On the other hand, due to the presence of the chelator, when the mixture is agitated for a period of time such as 30 minutes, 1 hour, 1.5 hours, 2 hours or similar, the chelator compound forms a metal-ion complex with at least one of the components of the metal composition based on the size of the components, with the chelator compound favoring the larger metal components over the smaller metal components. In other words, given two metal ions (e.g., La³⁺ and Dy³⁺) the chelator favors bonding with a greater percentage of one of the metal ions (e.g., La³⁺) than the other metal ion (e.g., Dy³⁺). The metal-ion complex with the coordinated metal is thus dissolved in the solvent, whereas the metal components that are left uncomplexed by the chelator, i.e., that do not form a metal-ion complex with the chelator compound, remain in a solid state in the mixture. Subsequently, the mixture is separated such as by filtration to obtain a solid phase and a liquid phase (i.e., filtrate, also referred to herein as the supernatant), in which the metal-ion complex is present in the liquid phase. After isolating the supernatant, the metal may be disassociated from the chelator compound in the supernatant to strip the metal from the compound. Particularly, an acid such as oxalic acid can be introduced to the supernatant to remove the metal from the chelator ligand and precipitate the metal as a metal oxalate. Subsequently, the resulting mixture can be filtered to separate the chelator compound (the solution) from the precipitated metal oxalate. Finally, the pH of the chelator compound in the solution can be adjusted to recover and recycle the chelator compound for reuse in another separation process such as the one just described.

### EXAMPLES

The present chelators and methods of use are further described in connection with the following laboratory examples, which are intended to be non-limiting. The examples include synthesis and characterization of specific embodiments of the chelators as well as rare-earth complexes including the same, and methods of separating rare-earth elements using the chelators.

All solvents and reagents used were of ACS grade or higher and were purchased from commercial sources. Solvents noted as dry were obtained following storage over 3 Å molecular sieves. Deionized water (≥18 MΩ·cm) was obtained from a Milli-Q Reference water purification system and used for all experiments, unless otherwise noted. Inductively coupled plasma (ICP) standard solutions of rare-earth elements (REEs) in dilute nitric or hydrochloric acid were obtained from VWR (Radnor, PA, USA) or High Purity Standards (Charleston, SC, USA). 6,9-dioxa-3,12-diazatetradecane-1,14-diol (structure 2) was either synthesized directly according to a literature procedure, or indirectly via its benzylated intermediate 1 as described below. Methyl 6-(bromomethyl)picolinate (structure 3) was synthesized according to literature starting from methyl 6-(hydroxymethyl)pyridine-2-carboxylate (obtained from Chem-Impex Int'l, Wood Dale, IL, USA). Buffers for mixed rare-earth hydroxide dissolution experiments were prepared using CAPS (≥99%, obtained from Sigma-Aldrich) or CHES (obtained from Sigma-Aldrich) buffers. Each buffer was adjusted to the desired pH using a small volume of 10 N NaOH (obtained from VWR) or 6 M HCl (prepared from concentrated HCl, Aristar Plus grade, obtained from VWR).

Automated flash chromatography was performed on a CombiFlash Rf+ (Teledyne ISCO, Lincoln, NE). High-performance liquid chromatography (HPLC) instrumentation consisted of a CBM-40 communications bus module, two LC-20AR pumps, a DGU-405 5-channel degasser, and an SPD-40 UV/vis detector monitoring at 270 nm (Shimadzu, Japan). Analytical chromatography was carried out at a flow rate of 1.0 mL/min using an Ultra Aqueous C₁₈ column, 100 Å, 5 μm, 250 mm×4.6 mm (Restek, Bellefonte, PA). Semi-preparative purification was performed using an Ultra Aqueous C₁₈ column, 100 Å, 5 μm, 250×21.2 mm (Restek) at a flow rate of 14 ml/min. For analytical HPLC, prep HPLC, and reverse-phase CombiFlash, solvent A was H₂O with 0.1% trifluoroacetic acid (TFA); solvent B was CH₃OH with 0.1% TFA.

Nuclear magnetic resonance (NMR) spectra were recorded at 298 K on a Bruker AvanceIII 400 MHz spectrometer. Chemical shifts are reported in parts per million (ppm). 1H NMR and ¹³C{¹H} NMR spectra were acquired in CDCl₃, CD₃OD, or D₂O and referenced to the tetramethylsilane (TMS) internal standard (0 ppm), residual solvent peaks, or to an internal standard of CH₃CN (2.06 ppm, ¹H NMR; 1.47 ppm, ¹³C NMR), respectively. The splitting of proton resonances in the reported ¹H NMR spectra is defined as follows: s=singlet, d=doublet, t=triplet, q=quartet, m=multiplet, and br=broad. Elemental analysis was performed by Atlantic Microlab (Norcross, GA, USA). ICP-mass spectrometry (ICP-MS) was performed on an iCAP triple quadrupole ICP-MS spectrometer (ThermoFisher Scientific, Waltham, MA) equipped with a prepFAST M5 autosampler (Elemental Scientific, Omaha, NE, USA) and Qtegra software. Powder X-ray diffraction (PXRD) spectra were acquired on a Malvern PANalytical Empyrean diffractometer (Malvern, UK) operated at 45 kV and 40 mA (scanning step: 0.026° per step). The diffraction patterns were recorded in the range of 5-90° and identified using the Malvern Panalytical HighScore software. High-resolution mass spectra (HRMS) were obtained on a Q Exactive HF Orbitrap mass spectrometer (Thermo Scientific, Waltham, MA, USA) at 240,000 resolution in positive electrospray ionization (ESI) mode. Low resolution mass spectra (LRMS) were acquired on an expression CMS mass spectrometer (Advion Inc., Ithaca, NY, USA) using positive mode electrospray ionization. Samples were introduced using Open Port Sampling Interfaces (OPSIs) on both instruments.

### Synthesis of acyclopa (6,6′-(2,11-bis(2-hydroxyethyl)-5,8-dioxa-2,11-diazadodecane-1,12-diyl)dipicolinic acid

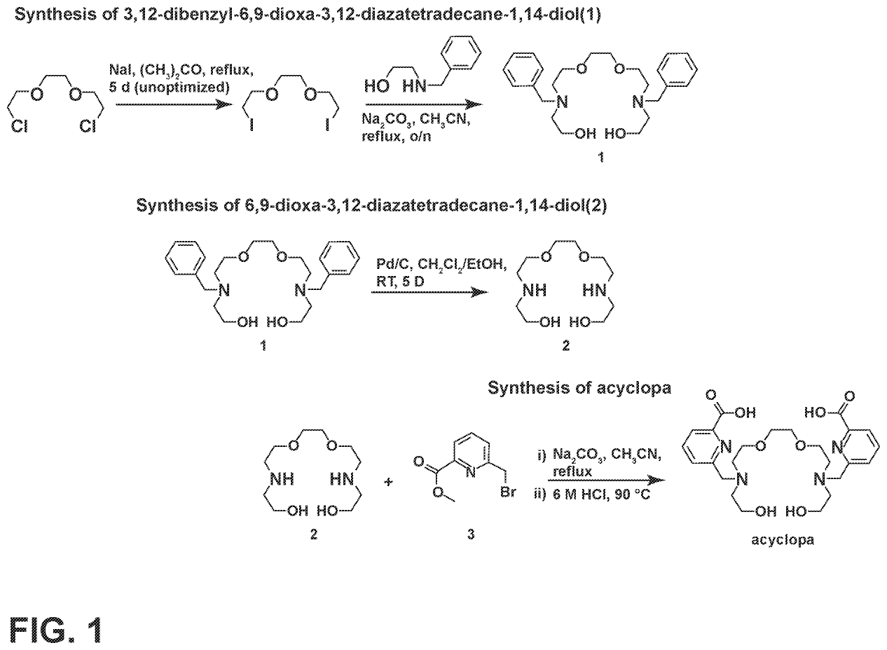

The chemical structure of acyclopa is shown in Formula (II) above. An exemplary process for synthesizing acyclopa is provided in FIG. 1. The first set of reaction steps in the illustrated process forms 3,12-dibenzyl-6,9-dioxa-3,12-diazatetradecane-1,14-diol from 1,2-Bis(2-iodoethoxy)ethane as the starting material. 1,2-Bis(2-iodoethoxy)ethane (45.3 g, 0.12 mol) was prepared from 1,2-bis(2-chloroethoxy)ethane in nearly quantitative yield according to an established literature method and used without further purification. This pale-yellow liquid was added to a mixture of N-benzylethanolamine (37.3 g, 0.25 mol) and Na₂CO₃ (78.6 g, 0.74 mol)) in CH₃CN (500 mL). The resulting off-white suspension was stirred overnight at reflux, cooled, and filtered. The faintly yellow filtrate was concentrated on a rotary evaporator at 50° C. The residue was taken up in CH₂Cl₂ (500 mL) and washed with H₂O (3×100 mL). The organic phase was dried over sodium sulfate and concentrated at 40° C. to a pale-yellow oil. The crude product was further purified by flash column chromatography on normal-phase silica using CH₂Cl₂/CH₃OH (0-5 min, 0% CH₃OH; 5-50 min, linear gradient to 10% CH₃OH). Pure fractions were combined and concentrated to yield 3,12-dibenzyl-6,9-dioxa-3,12-diazatetradecane-1,14-diol (structure 1) as a very pale-yellow oil (31.73 g, 62% over 2 steps). 1H NMR (400 MHZ, CDCl₃) δ 7.35-7.21 (m, 10H), 3.71 (s, 4H), 3.59-3.50 (m, 12H), 3.28 (br s, 2H), 2.75 (t, J=5.6 Hz, 4H), 2.71 (t, J=5.6 Hz, 4H). The spectrum matches that obtained for 3,12-dibenzyl-6,9-dioxa-3,12-diazatetradecane-1,14-diol (structure 1) synthesized previously via a different route. ¹³C{¹H} NMR (100 MHZ, CDCl₃) δ 139.25, 129.02, 128.43, 127.21, 70.45, 69.86, 59.59, 59.24, 56.06, 53.09.

The second set of reaction steps in the illustrated process forms 6,9-dioxa-3,12-diazatetradecane-1,14-diol from 3,12-dibenzyl-6,9-dioxa-3,12-diazatetradecane-1,14-diol obtained above. 3,12-dibenzyl-6,9-dioxa-3,12-diazatetradecane-1,14-diol (structure 1) (6.29 g, 0.015 mol) in CH₂Cl₂ (20 mL) and 10% Pd/C (0.95 g, Type 487, dry) were combined in a flask under Ar. EtOH (150 mL) was slowly added to this mixture. The flask was filled with H₂ via a balloon, and the reaction mixture was stirred at RT for 5 d (unoptimized). The mixture was filtered, and the filtrate was concentrated at reduced pressure to give the title 6,9-dioxa-3,12-diazatetradecane-1,14-diol (structure 2) as a light-orange waxy solid in quantitative yield (3.66 g). 1H NMR (400 MHZ, CDCl₃) δ 3.68-3.58 (m, 12H), 2.80 (t, J=5.2 Hz, 4H), 2.74 (t, J=5.5 Hz, 4H).

The third set of reaction steps in the illustrated process forms acyclopa from 6,9-dioxa-3,12-diazatetradecane-1,14-diol. Methyl 6-(bromomethyl)picolinate (structure 3) (3.98 g, 17.3 mmol), 6,9-dioxa-3,12-diazatetradecane-1,14-diol (structure 2 obtained above) (2.05 g, 8.7 mmol), Na₂CO₃ (5.51 g, 52.0 mmol), and dry CH₃CN (150 mL) were added to a 250-mL round-bottom flask. The resulting suspension was equipped with a condenser and drying tube and heated at reflux for 2 h, at which point no starting material (methyl 6-(bromomethyl)picolinate; structure 3) was detected by thin layer chromatography (TLC, 1:1 hexanes:ethyl acetate). The yellow suspension was then concentrated by rotary evaporation at 60° C. The resulting crude residue was taken up in H₂O (75 mL) and extracted with CH₂Cl₂ (2×250 mL). The combined organic layers were washed with 15 mL H₂O, dried over anhydrous sodium sulfate, and concentrated by rotary evaporation at 40° C. to a yellow-orange oil which was a dimethyl ester intermediate (4.474 g, 97% crude yield). 1H NMR (400 MHZ, CDCl₃) δ 8.00-7.96 (t, J=6.2 Hz, 2H), 7.81-7.73 (m, J=7 Hz, 4H), 3.99 (s, 10H), 3.80 (t, J=6.4 Hz, 2H), 3.60 (q, J=5.6 Hz, 4H), 3.45 (t, J=5.8 Hz, 8H), 2.84 (t, J=5.2 Hz, 4H), 2.77 (t, J=4.8 Hz, 4H). ¹³C{¹H} NMR (101 MHZ, CDCl₃) δ 165.85, 160.92, 147.24, 137.51, 126.12, 123.65, 70.37, 69.67, 60.97, 59.55, 56.81, 53.93, 52.95. HRMS (ESI) m/z=535.27628 ([M+H]⁺, Calcd 535.27624), 557.25816 ([M+Na]⁺, Calcd 557.25818), 268.14176 ([M+2H]²⁺, Calcd 268.14176). Analytical HPLC: t_{R}=16.6 min [10% B (0-5 min), 10-100% B (5-25 min)].

6 M HCl (20 mL) was added to a portion of the intermediate dimethyl ester (2.15 g, 4.0 mmol), and the resulting opalescent yellow-orange solution was heated to 90° C. for 24 h. The solution was then concentrated under reduced pressure at 60° C. The crude oil was dissolved in 10% MeOH in H₂O containing 0.1% TFA and purified by reverse-phase semi-preparative HPLC [10% B (0-5 min), 10-100% B (5-25 min)]. Pure fractions were combined, and the solvent was removed in vacuo. To prepare the hydrochloride salt, the residue was redissolved in 6 M HCl (10 mL) and concentrated under reduced pressure at 55° C. This step was performed a total of five times. The product was then twice redissolved in H₂O (10 mL each) and concentrated to remove any excess acid. Lyophilization afforded acyclopa as a pale-yellow, crystalline solid (1.50 g, 2.07 mmol, 51% yield from the intermediate dimethyl ester). Elemental analysis is consistent with isolation of a pentahydrochloride salt with two waters of hydration. ¹H NMR (400 MHZ, D₂O, pD 1-2) δ 8.13-8.06 (m, J=6.4 Hz, 4H), 7.72 (d, J=7.2 Hz, 2H), 4.76 (s, 4H), 3.95 (t, J=4.4 Hz, 4H), 3.89 (t, J=4.4 Hz, 4H), 3.63 (s, 4H), 3.60 (s, 4H), 3.50 (t, J=5 Hz, 4H). ¹³C{¹H} NMR (101 MHz, D₂O, pD 1-2) δ 167.86, 150.48, 147.09, 140.68, 128.60, 126.11, 70.31, 64.65, 58.11, 56.67, 55.84, 54.56. Elem. anal. Found: C, 40.18; H, 6.08; N, 7.85; Cl, 23.99. Calcd for C₂₄H₃₄N₄O₈·5HCl·2H₂O: C, 39.77; H, 5.98; N, 7.73; Cl, 24.45. HRMS (ESI) m/z=507.24478 ([M+H]⁺, Calcd 507.24494), 254.12599 ([M+2H]²⁺, Calcd 254.12611). Analytical HPLC: t_{R}=14.8 min [10% B (0-5 min), 10-100% B (5-25 min)].

### Synthesis of Acyclopa-XL

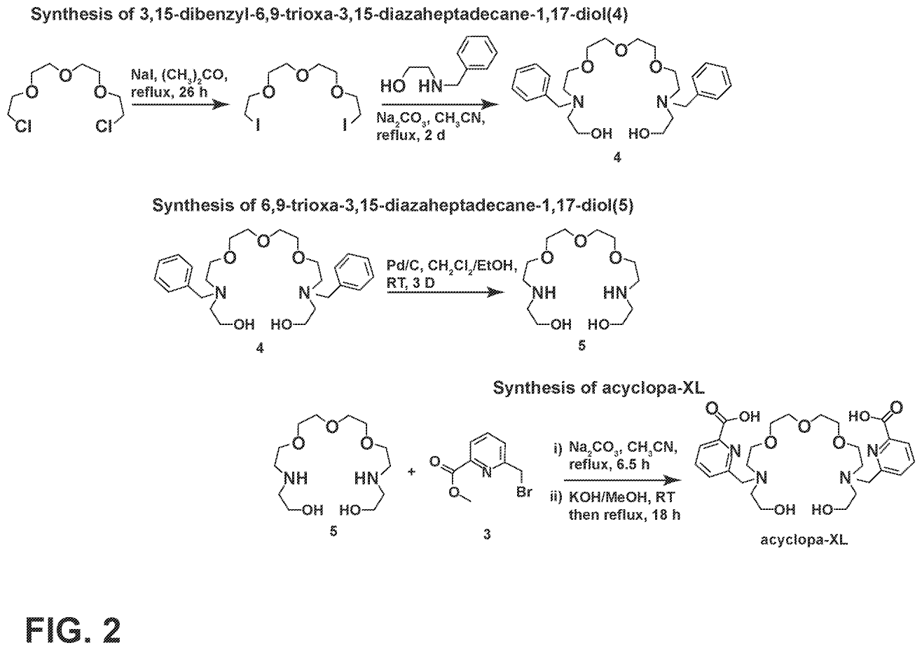

The chemical structure of acyclopa-XL is shown in Formula (III) above. An exemplary process for synthesizing acyclopa-XL is provided in FIG. 2. The first set of reaction steps in the illustrated process forms 3,15-dibenzyl-6,9,12-trioxa-3,15-diazaheptadecane-1,17-diol from diethylene glycol bis(2-chloroethyl) ether. Diethylene glycol bis(2-iodoethyl) ether (45.6 g, 0.11 mol) was prepared from diethylene glycol bis(2-chloroethyl) ether in nearly quantitative yield according to an established literature method, except the crude product was washed with 10% w/w sodium thiosulfate and used without further purification. This pale-yellow liquid was combined with N-benzylethanolamine (33.3 g, 0.22 mol) and Na₂CO₃ (70.2 g, 0.66 mol)) in dry CH₃CN (600 mL). The resulting pale-yellow suspension was stirred for 2 d at reflux, cooled, and filtered. The filtrate was concentrated by rotary evaporator at 60° C. to a pale-yellow solid. This solid was taken up in CH₂Cl₂ (400 mL) and washed with H₂O (1×200 mL, 100 mL, 50 mL). The organic phase was dried over sodium sulfate and concentrated under reduced pressure to a pale-yellow liquid. The crude product was further purified by flash column chromatography on normal-phase silica using CH₂Cl₂/CH₃OH (0-5 min, 0% CH₃OH; 5-50 min, linear gradient to 10% CH₃OH). Pure fractions were combined and concentrated to yield 3,15-dibenzyl-6,9,12-trioxa-3,15-diazaheptadecane-1,17-diol (structure 4) as a pale-yellow oil (15.87 g). ¹H NMR (400 MHZ, CDCl₃) δ 7.33-7.21 (m, 10H), 3.70 (s, 4H), 3.65-3.61 (m, 4H), 3.59-3.50 (m, 12H), 2.74 (t, J=5.6 Hz, 4H), 2.70 (t, J=5.4 Hz, 4H). The spectrum matches that obtained for 3,15-dibenzyl-6,9,12-trioxa-3,15-diazaheptadecane-1,17-diol (structure 4) synthesized previously via a different route. ¹³C{¹H} NMR (100 MHz, CDCl₃) δ 139.11, 128.90, 128.32, 127.11, 70.60, 70.35, 69.65, 59.47, 59.11, 55.94, 52.98.

The second set of reaction steps in the illustrated process forms 6,9,12-trioxa-3,15-diazaheptadecane-1,17-diol from 3,15-dibenzyl-6,9,12-trioxa-3,15-diazaheptadecane-1,17-diol. 3,15-dibenzyl-6,9,12-trioxa-3,15-diazaheptadecane-1,17-diol (structure 4) (15.85 g, 0.034 mol) in CH₂Cl₂ (30 mL) and 10% Pd/C (2.42 g, Type 487, dry) were combined in a 300 mL round-bottom flask under Ar. EtOH (˜250 mL) was slowly added to this mixture. The flask was filled with H₂ via a balloon, and the reaction mixture was stirred at RT. After 2 d, the reaction mixture was transferred to a 1 L flask to provide more headspace, and additional Pd/C (0.7 g) was added. After stirring at RT under H₂ for another 1 d, the mixture was filtered. The filtrate was concentrated at reduced pressure to give 6,9,12-trioxa-3,15-diazaheptadecane-1,17-diol (structure 5) as a very pale-yellow oil in quantitative yield (9.74 g). ¹H NMR (400 MHZ, CDCl₃) δ 3.74-3.68 (m, 4H), 3.67-3.60 (m, 12H), 2.82 (t, J=5.0 Hz, 4H), 2.75 (t, J=5.0 Hz, 4H). ¹³C{¹H} NMR (100 MHZ, CDCl₃) δ 70.35, 70.13, 69.30, 60.83, 51.92, 48.78.

The third set of reaction steps in the illustrated process forms acyclopa-XL from 6,9,12-trioxa-3,15-diazaheptadecane-1,17-diol. 6,9,12-trioxa-3,15-diazaheptadecane-1,17-diol (structure 5) (9.74 g, 0.035 mol), Na₂CO₃ (26.29 g, 0.25 mol), and CH₃CN (500 mL) were added to a 1 L round-bottom flask, followed by a solution of methyl 6-(bromomethyl)picolinate (structure 3) (15.97 g, 0.069 mol) in CH₃CN (150 mL). The suspension was equipped with a condenser and drying tube and heated at reflux for 6.5 h, at which point no starting material (6,9,12-trioxa-3,15-diazaheptadecane-1,17-diol) was detected by thin layer chromatography (TLC, 1:1 hexanes:ethyl acetate). The reaction suspension was then concentrated by rotary evaporation at 55° C. The resulting crude residue was taken up in H₂O (300 mL) and extracted with CH₂Cl₂ (1×1000 mL, then 1×500 mL). The combined organic layers were washed with 50 mL H₂O, dried over anhydrous sodium sulfate, and concentrated by rotary evaporation at 40° C. to an amber-orange oil (dimethyl ester intermediate, 19.91 g). This product was used in the next step without further purification. 1H NMR (400 MHZ, CDCl₃) δ 8.00 (d, J=7.6 Hz, 1H), 7.81 (t, J=7.7 Hz, 2H), 7.73 (d, J=7.9 Hz, 2H), 3.99 (m, 10H), 3.70-3.50 (m, ˜16H), 2.83 (t, J=5.4 Hz, 4H), 2.78 (t, J=5.1 Hz, 4H). ¹³C{¹H} NMR (101 MHz, CDCl₃) δ 165.80, 160.92, 147.26, 137.50, 126.14, 123.61, 77.34, 70.59, 70.39, 69.61, 60.90, 59.53, 56.75, 53.93, 52.90. LRMS (ESI) m/z=290.1 ([M+2H]²⁺, Calcd 290.2).Analytical HPLC: t_{R}=17.45 min [10% B (0-5 min), 10-100% B (5-25 min)].

KOH (4.51 g in pellet form, 0.080 mol) was added to an orange solution of intermediate dimethyl ester (19.91 g, ˜0.034 mol) in MeOH (400 mL), and the reaction mixture was stirred at RT. After 15 h, additional KOH was added (2.5 g, 0.045 mol), and the reaction mixture was heated at reflux for 3 h to drive the hydrolysis to completion. The cloudy, orange solution was then concentrated under reduced pressure at 40° C. The crude residue was dissolved in 10% MeOH/H₂O (20 mL), and the pH of the solution was adjusted to ˜1 using concentrated TFA. The solution was loaded portion-wise onto a RediSep Rf Gold C18Aq column and purified by flash chromatography (CombiFlash) using a reduced flow rate (35 mL/min). The following method was used: 0% B (0-10 min), 0-100% B (10-50 min). Fractions containing product were combined, and the solvent was removed in vacuo. The product was redissolved in H₂O and lyophilized to afford acyclopa-XL as a pale-yellow oil (20.01 g). Elemental analysis is consistent with acyclopa-XL·2.5CF₃COOH·2H₂O (0.023 mol, 66% yield over two steps). 1H NMR (400 MHz, D₂O, pD 1-2) δ 8.16 (d, J=7.9 Hz, 2H), 8.10 (t, J=7.7 Hz, 2H), 7.75 (d, J=7.9 Hz, 2H), 4.78 (s, 4H), 3.97 (t, J=5.1 Hz, 4H), 3.87 (t, J=4.8 Hz, 4H), 3.64-3.56 (m, 12H), 3.51 (t, J=5.1 Hz, 4H). ¹³C{¹H} NMR (101 MHZ, D₂O, pD 1-2) δ 167.99, 163.98-162.93 (q, TFA), 150.60, 147.34, 140.66, 128.65, 126.12, 121.27-112.58 (q, TFA), 70.31, 70.15, 64.67, 58.14, 56.79, 55.96, 54.56. Elem. anal. Found: C, 42.92; H, 5.16; N, 6.31; F, 16.51. Calcd for C₂₆H₃₈N₄O₉·2.5CF₃COOH·2H₂O: C, 42.71; H, 5.15; N, 6.43; F, 16.35. HRMS (ESI) m/z=551.27076 ([M+H]⁺, Calcd 551.27115), 276.13904 ([M+2H]²⁺, Calcd 276.13922). Analytical HPLC: t_{R}=15.62 min [10% B (0-5 min), 10-100% B (5-25 min)].

### Synthesis of La-acyclopa Complex

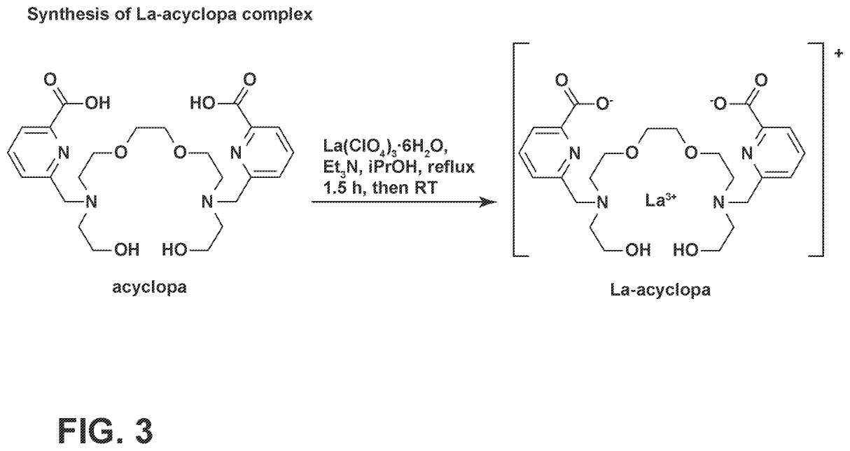

The chemical structure of La-acyclopa is shown in Formula (V) above. An exemplary process for synthesizing La-acyclopa is provided in FIG. 3. A 25 mL round-bottom flask was charged with acyclopa·5HCl·2H₂O (0.059 g, 0.081 mmol), isopropanol (2 mL), and triethylamine (90 μL, 0.649 mmol). The resulting suspension was heated to reflux for 25 minutes, during which time the precipitate dissolved. A solution of La(CIO₄)₃ (0.049 g, 0.090 mmol) in isopropanol (1 mL) was then added dropwise, producing a pale-yellow precipitate which dissolved shortly after. The clear, yellow solution was then refluxed for an additional hour, producing a cloudy suspension with pale-yellow precipitate. The suspension was cooled to room temperature and stirred for an additional two days to fully precipitate the complex. The resulting off-white suspension was then centrifuged, and the clear, yellow supernatant was decanted. The pellet was further washed with isopropanol (2×1 mL). Following the final wash, the pellet was resuspended in diethyl ether (4 mL), concentrated to a soft dryness on a rotary evaporator at room temperature, and further air dried to afford a white solid (0.054 g).

### Synthesis of Y-acyclopa Complex

A 20 mL scintillation vial was charged with acyclopa·2.65TFA (0.1887 g, 0.226 mmol), isopropanol (3.5 mL), and triethylamine (0.1808 g, 1.786 mmol). The resulting suspension was heated to reflux for 20 minutes, during which time the precipitate dissolved. A solution of Y(CIO₄)₃ (0.2002 g, 0.169 mmol) was then added, producing a pale-orange precipitate which dissolved shortly after. The clear, orange solution was then refluxed for an additional hour, producing a cloudy suspension. The suspension was cooled to room temperature and stirred for an additional three days to fully precipitate the complex. The resulting off-white suspension was then centrifuged, and the clear, orange supernatant was decanted. The pellet was further washed with isopropanol (3×5 mL). Following the final wash, the solid was air dried to afford an orange oil-like solid (0.0629 g).

### Single-Crystal X-Ray Diffraction Studies

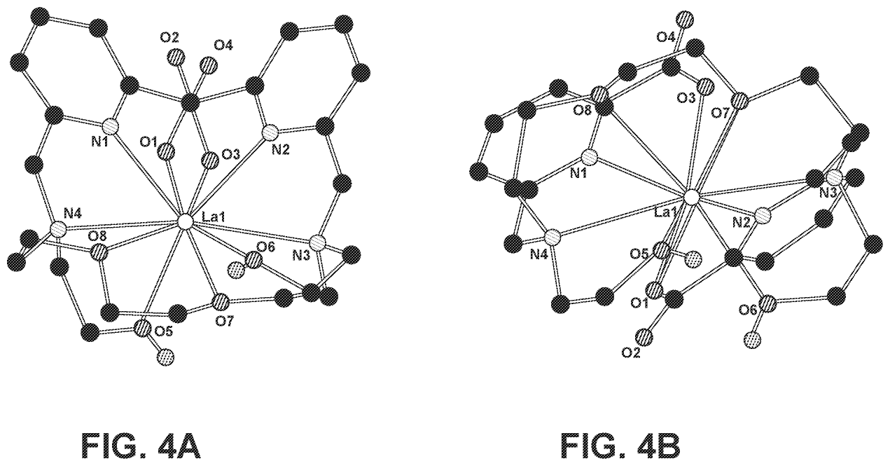

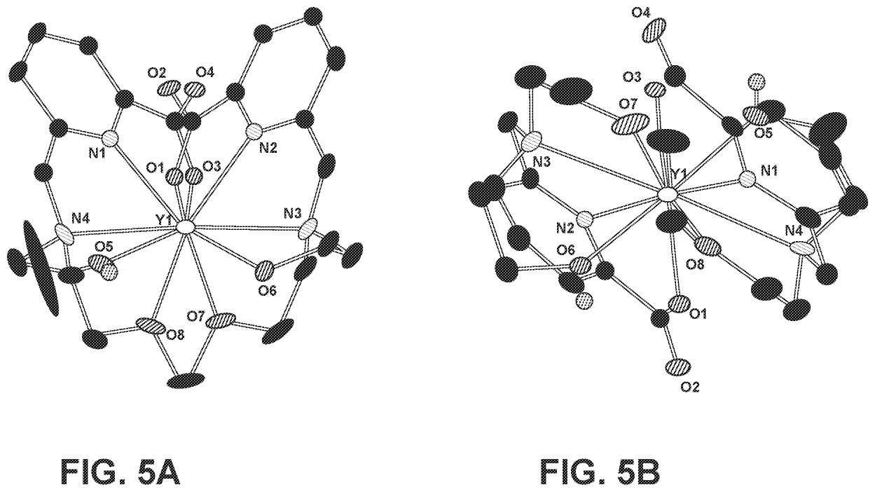

Single crystals of [La(acyclopa)]CIO₄·DMF and [Y(acyclopa)]CIO₄·DMF were both obtained from slow diffusion of diethyl ether into a solution of the complex in N,N-dimethylformamide. Diffraction data were collected at 100 K on a Bruker D8 Advance Quest diffractometer with a graphite monochromator using Mo Kα radiation (λ=0.71073 Å). The frames were integrated with the Bruker SAINT software package using a narrow-frame algorithm. An empirical absorption correction using the Multi-Scan method SADABS was applied to the data. The structure was solved by direct methods using the Bruker SHELXTL Software Package, version 2019/1. All atoms except the H atoms were refined anisotropically. Hydrogen atoms were calculated and placed in idealized positions; alcohol H atoms in both La and Y complexes were located from difference Fourier maps and refined isotropically. The DMF molecules in the [Y(acyclopa)]CIO₄·DMF crystal were significantly disordered even though low temperature 100 K was used for the data collection. The disordered DMF molecules were all removed before applying the SQUEEZE command. As a result, there are A and B alerts in the checkcif files that are related to the voids in the structure and the unusually low density, which are both attributed to the SQUEEZE command. The resulting X-ray crystal structures of [La(acyclopa)]CIO₄·DMF and [Y(acyclopa)]CIO₄·DMF are shown in FIGS. 4A, 4B, 5A, and 5B. As can be seen from the drawings, the coordination sphere of La³⁺ is saturated by all 10 donor atoms of acyclopa and acyclopa-XL. This further supports that the ligand scaffold of acyclopa and acyclopa-XL can optimally accommodate and stabilize the large La³⁺ ion.

### Protonation Constants and Lanthanide Complex Stabilities by Potentiometric Titration

Protonation constants and lanthanide (Ln) stability constants of acyclopa and acyclopa-XL were obtained by potentiometric titration using either a Metrohm Titrando 888 titrator or an 855 Robotic Titrosampler connected to an 805 Dosimat. Both titration systems were equipped with Ross Orion combination electrodes (8103BN, ThermoFisher Scientific), Metrohm 806 exchange units with automatic burets (10 mL), and Tiamo 2.5 software. The titration vessel was fitted with a removable glass cell and thermostated at 25° C. using an Isotemp 500LC recirculating chiller (Fisher Scientific). CO₂ was excluded from the titration vessel using a small positive pressure of argon bubbled through 30 wt % KOH. Carbonate-free KOH (˜0.1 M) was prepared using freshly boiled H₂O (≥18 MΩ·cm) and semiconductor-grade KOH pellets (99.99% trace metals basis, Sigma-Aldrich, stored under Ar). The KOH solution was standardized against potassium hydrogen phthalate (BioXtra, ≥99.95%, Sigma-Aldrich). HCl (0.1 M, Metrohm Certified Titrants) was titrated against Tris base (Ultrapure Bioreagent, J. T. Baker) to verify its concentration. Potassium hydrogen phthalate and Tris base were both dried in an oven for at least 2 h at 110° C. prior to use. All titration solutions were maintained at a constant ionic strength of 0.1 M using KCl (BioUltra, ≥99.5%, Sigma-Aldrich) and equilibrated for 25 min prior to the addition of titrant.

Before every ligand or ligand-metal titration, the electrode was calibrated in terms of the hydrogen-ion concentration by titrating a solution of standardized HCl (0.005 M) containing supporting electrolyte (KCl=0.095 M) with standardized KOH. Data within the pH ranges of 2.3-3.2 and 10.8-11.3 were analyzed using the program Glee (version 3.0.21) to obtain the standard electrode potential (E₀) and slope factor. The H₂O ion product (pK_{w}=13.78) was taken from the literature. Stock solutions of acyclopa and acyclopa-XL were prepared in MQ H₂O. Their exact concentrations were determined potentiometrically from the two sharp endpoints of their titration curves using the formula ((V_{EP2}−V_{EP1})/npKₐ)*[KOH]. Stock solutions of LnCl₃ were prepared in standardized HCl (0.1 M), and their concentrations were determined by complexometric titration with Na₂H₂EDTA using xylenol orange as an indicator.

The protonation constants of the chelators and stability constants of their Ln³⁺ complexes were measured by adding standardized KOH to an aqueous solution (20 mL) of ligand (˜0.02 mmol), mineral acid (0.1 mmol HCl), and KCl (1.9 mmol) in the absence and presence of an equimolar amount of Ln³⁺ metal ion (0.02 mmol), respectively. The titration method employed a 0.1 mV min 1 drift limit and a maximum wait time of 180 s (ligand titrations) or 300 s (metal-ligand titrations) between additions of aliquots of base. For select metal-ligand titrations, further implementing a minimum wait time of either 0 s or 60 s between additions of base gave rise to the same stability constant values upon data refinement, indicating that equilibrium was attained rapidly after each addition of base in Ln/chelator systems.

The protonation and stability constants were refined using the program Hyperquad2013. Only the proton concentration was admitted as a refinable parameter. The protonation constants, defined in Equation 1 below, were calculated from the average of at least three independent titrations. With the protonation constants in hand, the stepwise stability constants (Equation 2 below) and protonation constants of the metal complexes (Equation 3 below) were calculated. Hydrolysis constants for the formation of [Ln(OH)]²⁺ in aqueous solution were included in the model. The errors provided correspond to 1 standard deviation.

$${K}_{ai} = \frac{[ {H}_{i} L ]}{[ {H}_{i - 1} L ] [ {H}^{+} ]} \qquad ( 1 )$$

$${K}_{ML} = \frac{[ ML ]}{[ M ] [ L ]} \qquad ( 2 )$$

$${K}_{{MH}_{n} L} = \frac{[ {MH}_{n} L ]}{[ {MH}_{n - 1} L ] [ H ]} \qquad ( 3 )$$

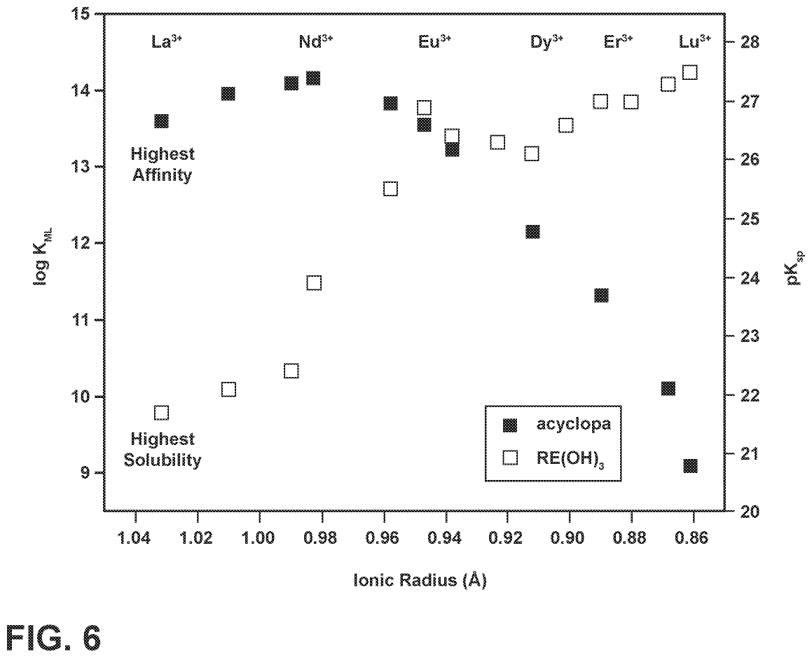

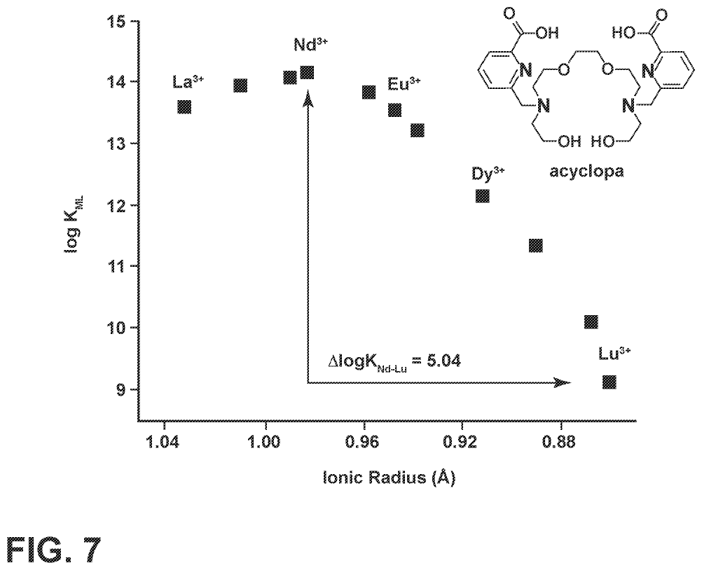

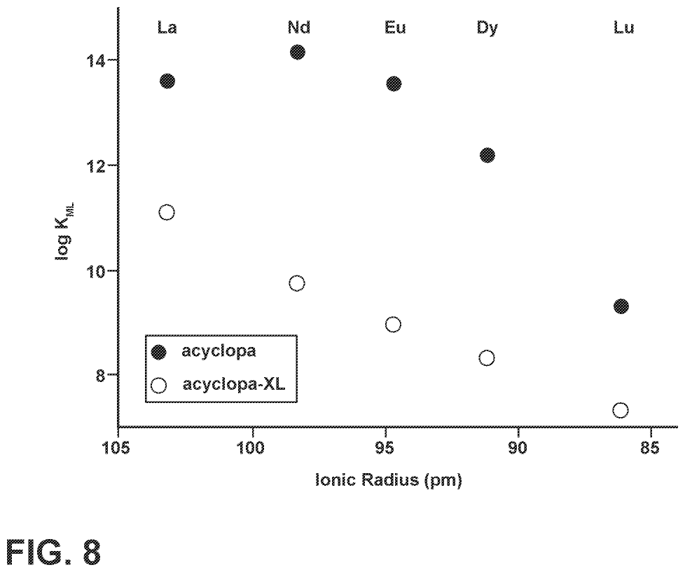

The stability constants (log K_{ML} values) of acyclopa and solubility products (pKₛₚ) of RE(OH)₃ as a function of the 6-coordinate ionic radius of each RE³⁺ ion are shown in FIG. 6. Acyclopa possesses high affinity for large, light REEs and low affinity for small, heavy REEs (Δ log K_{La-Lu}=4.27). Notably, this selectivity bias is synergistic with the solubility bias of RE hydroxides, which is skewed towards large RE hydroxides having enhanced solubility over small RE hydroxides. For example, the stability constants in FIG. 6 reveal that the La-acyclopa complex is more than four orders of magnitude more stable than the Lu-acyclopa complex. Notably, the dissolution efficiency of a given ligand for a metal hydroxide is expected to scale with its thermodynamic binding affinity. This trend is predicted to lead to a more pronounced separative leaching of large REEs from caustically cracked monazite (rare earth phosphate). The stability constants (log K_{ML} values) of acyclopa as a function of the 6-coordinate ionic radius of each Ln³⁺ ion are shown in FIG. 7 and a comparison of stability constants (log K_{ML} values) of acyclopa versus acyclopa-XL as a function of the 6-coordinate ionic radius of each Ln³⁺ ion are shown in FIG. 8.

### Preparation of Synthetic Mixed Rare-Earth Phosphate

Synthetic mixed rare-earth phosphate (REPO₄) was prepared by direct precipitation using a method adapted from the literature. Specifically, La(NO₃)₃·6H₂O, Eu(NO₃)₃·5H₂O, Nd(NO₃)₃·6H₂O, Dy(NO₃)₃·6H₂O, and Y(NO₃)₃·6H₂O (0.024 mol of each) were combined and diluted to 75 mL with H₂O. A minor amount of RE(NO₃)₃ remained undissolved and was removed by centrifugation. In a 100 ml beaker, 85% H₃PO₄ (20 mL, ˜0.30 mol) was heated at 150° C. with stirring for 2 h to evaporate free H₂O. The RE(NO₃)₃ solution was transferred to an addition funnel and carefully added dropwise to the hot H₃PO₄ over the course of 3 h. Upon the addition of each drop, H₂O was observed to boil off. After the addition of the RE(NO₃)₃ solution was complete, the resulting suspension was stirred overnight (˜12 h) at 120° C. The suspension was then cooled and washed copiously with H₂O until the pH of the filtrate was increased to ˜6. Once this pH was reached, the solid was washed twice with EtOH, dried overnight in an oven at 150° C., and further calcined at 900° C. for 5 h. The resulting pale-purple powder (20.02 g) comprising (La,Nd,Eu,Dy,Y)PO₄ was characterized by PXRD.

### Preparation of Synthetic Mixed Rare-Earth Hydroxide Via Caustic Cracking

To obtain (La,Nd,Eu,Dy,Y)OH₃ for leaching studies, (La,Nd,Eu,Dy,Y)PO₄ obtained as described above was caustically cracked as follows. In a Parr™ General Purpose Acid Digestion Bomb, 2.5 g of (La,Nd,Eu,Dy,Y)PO₄ was contacted with 3.1 mL of a freshly made solution of 50 wt % NaOH. The digestor was sealed and placed in the oven at 150° C. for 4 h. Then, the Parr bomb was removed from the oven and left to cool overnight at ambient temperature. The solid was transferred into a centrifuge tube and washed 4 times with freshly dispensed MQ H₂O (˜50 mL each). Then, the centrifuge tube containing the pelleted solid was covered with foil and placed in a vacuum oven at 60° C. to dry overnight. The resulting pale-purple powder (2.1 g) was lightly pulverized with mortar and pestle and characterized by PXRD.

### Leaching Methods

A solution of CHES (400 mM) and CAPS (400 mM) was prepared in H₂O. The pH was left unadjusted. Buffered solutions of acyclopa at pH 8.2, 9, and 10 were prepared by adding an aliquot of acyclopa (6.65 mL of a 75.17 mM aqueous stock solution) to a volumetric flask (25 mL) containing CHES/CAPS (12.5 mL). The solution was diluted with concentrated NaOH and H₂O to the desired final pH. The final ligand concentration was 20 mM and the final CHES and CAPS concentrations were 200 mM each. Buffered solutions of EDTA were prepared in an analogous manner. For control samples without chelator, CHES/CAPS buffer (200 mM each) was prepared separately for each pH.

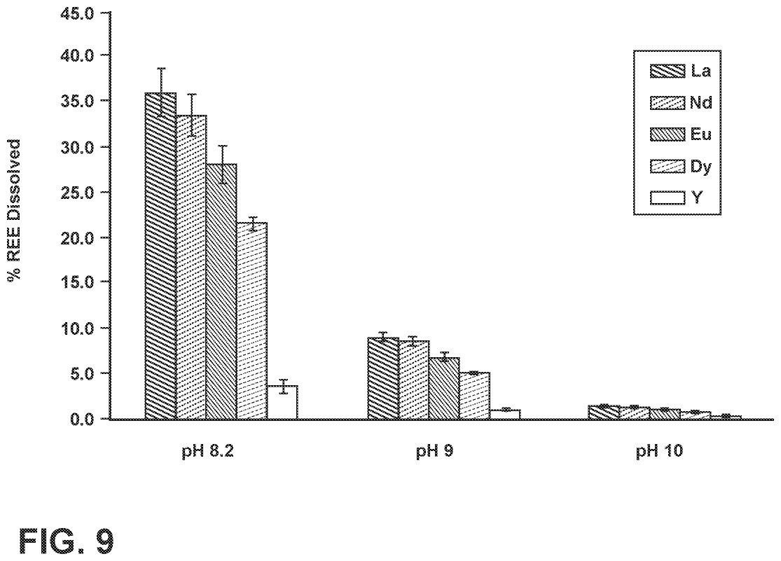

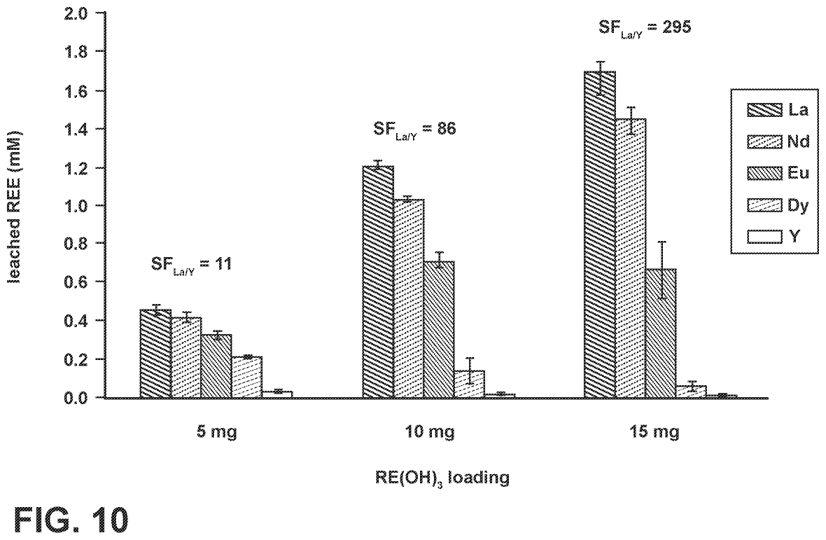

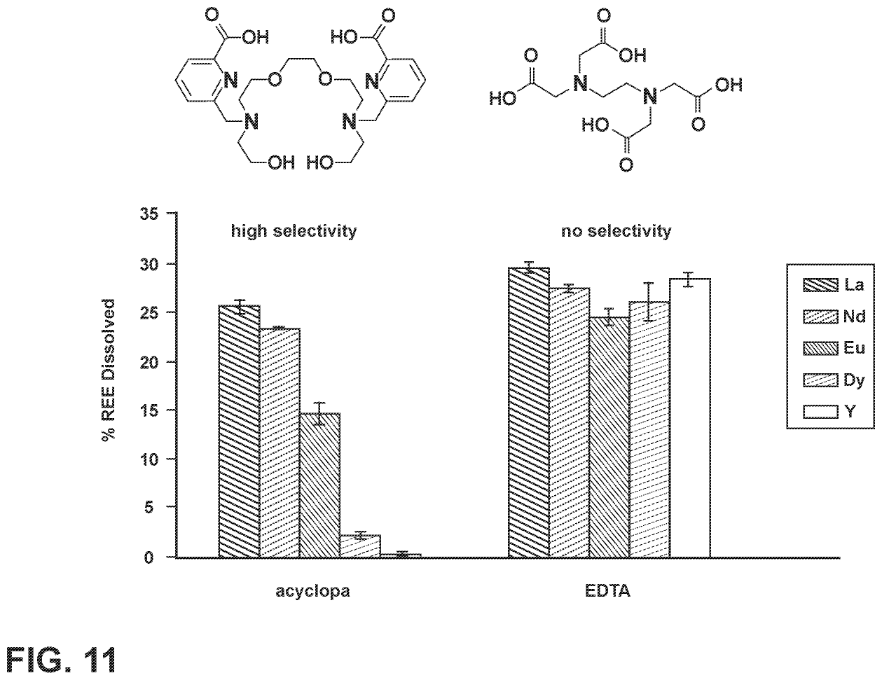

Leaching experiments were setup as follows: Various quantities (5±0.3 mg, 10±0.5 mg, and 15±0.5 mg) of (La,Nd,Eu,Dy,Y)OH₃ were massed into 2 mL flat-bottomed screw-cap polypropylene tubes. An aliquot of lixiviant solution or buffer only (1 mL) was added to each tube. The samples were rotated end-over-end at 35 RPM and ambient temperature (71±1° F.). At pre-determined time points, the suspensions were centrifuged, and an aliquot of the supernatant (10 μL) was carefully removed and placed into 2% HNO₃ (4.990 mL) for ICP-MS analysis. The samples were shaken to break up the pellets and returned to the rotating wheels. At the final time point, the suspensions were filtered via a 96-well filter plate (Pall AcroPrep Advance 0.2 μm Supor Short Tip) and sampled for ICP-MS. The final pH of representative samples was recorded. Calculation of percent rare earth hydroxide dissolved for each sample was carried out by comparison to 5±0.3 mg, 10±0.5 mg, and 15±0.5 mg of (La,Nd,Eu,Dy,Y)OH₃ fully dissolved using 6 M HCl (1 mL) according to the equation below. Also, the separation factor was calculated according to the equation below. The leaching of REEs (expressed as percent dissolution) from (La,Nd,Eu,Dy,Y)OH₃ by acyclopa as a function of pH (pH 8.2, pH 9, or pH 10) using a CHES/CAPS buffer, RT, 26 h, 20 mM lixiviant, and 5 mg/mL (La,Nd,Eu,Dy,Y)OH₃ are shown in FIG. 9. The leaching of REEs (expressed as concentration) from (La,Nd,Eu,Dy,Y)OH₃ by acyclopa as a function of solid loading at a pH of 9 using a CHES/CAPS buffer, RT, 26 h, 20 mM lixiviant, and 5-15 mg/mL (La,Nd,Eu,Dy,Y)OH₃ are shown in FIG. 10. Increasing the solid loading in each sample significantly increases separative leaching of La from Y by acyclopa, resulting in higher La/Y separation factors (SFs). Separation factor (SF) of Ln1/Ln2=([Ln1]_{filtrate}/[Ln1]_{solid})/([Ln2]_{filtrate}/[Ln2]_{solid}). The leaching (percent dissolution) of REEs from (La,Nd,Eu,Dy,Y)OH₃ by acyclopa versus EDTA at a pH of 8.2 using a CHES/CAPS buffer, RT, 26 h, 20 mM lixiviant, and 15 mg/mL (La,Nd,Eu,Dy,Y)OH₃ is shown in FIG. 11. The large-ion selective chelator acyclopa preferentially leaches large over small REEs from the hydroxide mixture, whereas the small-ion selective chelator EDTA fails to demonstrate any selectivity with respect to leaching.

$$\% REE dissolved = \frac{concentration of REE in filtered supernatant}{concentration of REE in sample fully dissolved with 6 M HCl}$$

$$Separation factor ( SF ) of REE 1 / REE 2 = ( {[ REE 1 ]}_{filtrate} / {[ REE 1 ]}_{solid} ) / ( {[ REE 2 ]}_{filtrate} / {[ REE 2 ]}_{solid} )$$

Recovery and Reuse of Acyclopa from Leaching Solutions

The recycling of acyclopa from pregnant leach solutions was investigated using oxalic acid. Oxalic acid (H₂C₂O₄) is known to react with REEs to form REE oxalate complexes, which are highly insoluble. Thus, it follows that acyclopa may be regenerated via the following reaction:

$$2 REE - acyclopa + 3 {H}_{2} {C}_{2} {O}_{4} \to {{REE}_{2} ( {C}_{2} {O}_{4} )}_{3} ( ↑ ) + acyclopa$$

1 equiv of oxalic acid indicates that 3 moles of oxalic acid are being used per 2 moles of REE.

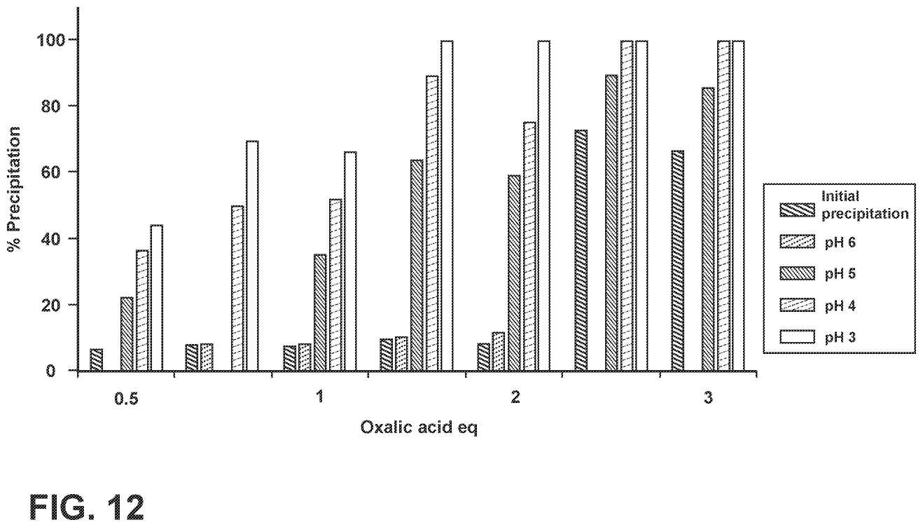

The release of REEs from acyclopa and their subsequent precipitation as REE₂(C₂O₄)₃ was investigated as a function of pH and oxalic acid equivalents. Pregnant leach solutions were prepared at pH 8.2 using acyclopa and La(OH)₃, and varying equivalents of H₂C₂O₄ were added. The pH of the samples was reduced stepwise to pH 6, 5, 4, and 3 using HCl. The concentration of La remaining in the supernatant at each pH was analyzed by ICP-MS. The release of REEs from acyclopa and their subsequent precipitation as REE₂(C₂O₄)₃ as a function of pH and oxalic acid equivalents is shown in FIG. 12.

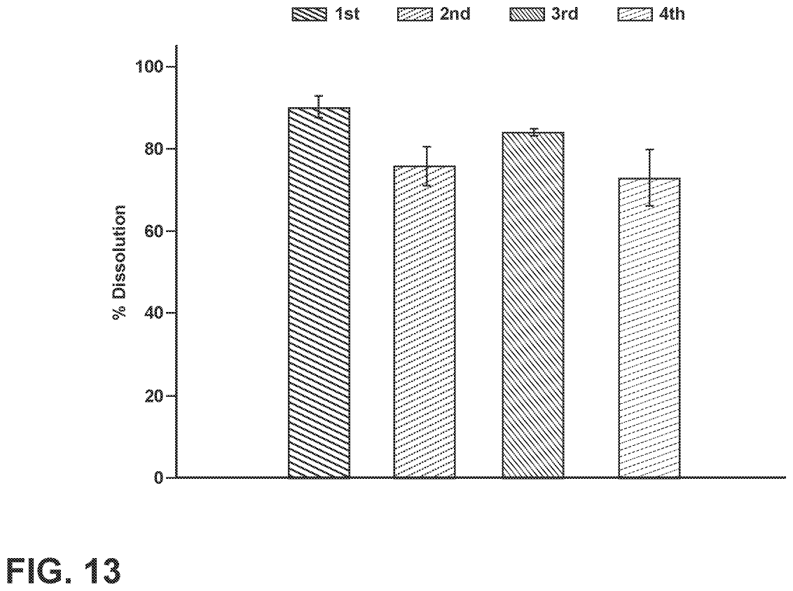

Next, the ability to reuse acyclopa in multiple leach cycles was investigated. Leaching samples were prepared as described above at pH 8.2 using acyclopa and La(OH)₃. Under the conditions used, nearly all of the La(OH)₃ was dissolved initially. To this solution, 2 equivalents of oxalic acid were added, and the pH was adjusted to 3 using HCl. The resulting precipitate was removed. The pH of the filtrate was re-adjusted to 8.2 using NaOH, and another portion of La(OH)₃ was added. The suspension was stirred for 24 h, and the percent La dissolved was measured by ICP-MS. In subsequent precipitation cycles, only 1 equivalent of oxalic acid was added. Using this method, ˜75% dissolution was maintained over 4 dissolution/precipitation cycles. The results are shown graphically in FIG. 13.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A chelator having a composition comprising:
a compound having a chemical structure of formula (I): 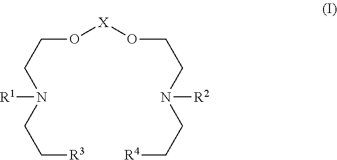
wherein X is a linking group selected from one of an ethyl, a propyl, a diethyl ether, a cyclohexyl, and a benzyl;
wherein each of R¹ and R² is a moiety including a terminal group selected from one of a carboxylic acid, a phosphinic acid, a phosphonic acid, a phenol, an amide, an amine, a carboxylic acid ester, a phosphinic acid ester, a phosphonic acid ester, and a phenol ether; and
wherein R³ and R⁴ are each selected from one of a hydroxy or an alkoxy group.

2. The chelator of claim 1, wherein R¹ and R² are each selected from one of the following moieties:

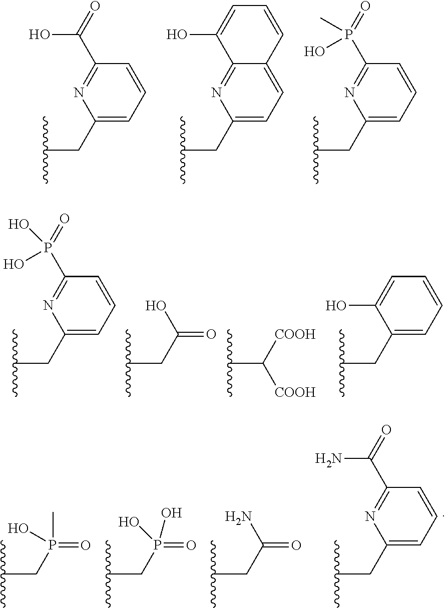

3. The chelator of claim 1, wherein one or both of R¹ and R² is a picolinic acid group.

4. The chelator of claim 1, wherein R³ and R⁴ are each one of OH or OCH₃.

5. The chelator of claim 1, wherein: (i) R¹ and R² are the same; (ii) R³ and R⁴ are the same; or (iii) both (i) and (ii).

6. The chelator of claim 1, wherein the compound has a chemical structure according to formula (II):

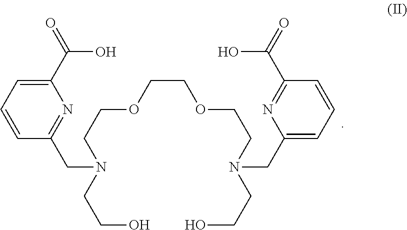 [SMILES: O=C(O)c1cccc(CN(CCO)CCOCCOCCN(CCO)Cc2cccc(C(=O)O)n2)n1]

7. The chelator of claim 1, wherein the compound has a chemical structure according to formula (III):

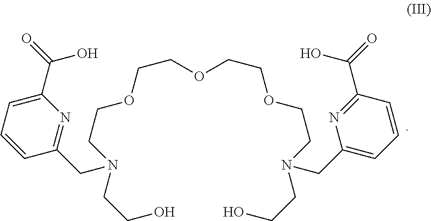 [SMILES: O=C(O)c1cccc(CN(CCO)CCOCCOCCOCCN(CCO)Cc2cccc(C(=O)O)n2)n1]

8. A metal-ion complex comprising:
a metal; and
the chelator of claim 1, wherein the chelator is a ligand coordinated with the metal.

9. The metal-ion complex of claim 8, wherein the metal is a rare-earth metal.

10. The metal-ion complex of claim 9, wherein the rare-earth metal is selected from lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), and yttrium (Y).

11. A method of separating a plurality of metals by size, the method comprising:
providing the chelator of claim 1 to separate the metals, wherein the chelator is reverse-size selective.

12. The method of claim 11, wherein the separation is one of leaching, crystallization, or solvent extraction.

13. The method of claim 11, wherein the plurality of metals are rare-earth metals.

14. The method of claim 13, wherein the plurality of metals includes two or more of lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), and yttrium (Y).

15. A method of recovering rare-earth elements by size, the method comprising:
dissolving a chelator in a solvent to obtain a first solution, wherein the chelator has a composition that includes a compound having a chemical structure of formula (I): 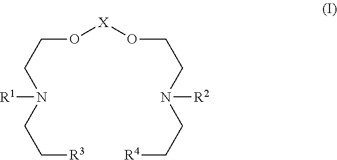
wherein X is a linking group selected from one of an ethyl, a propyl, a diethyl ether, a cyclohexyl, and a benzyl; and
wherein each of R¹ and R² is a moiety including a terminal group selected from one of a carboxylic acid, a phosphinic acid, a phosphonic acid, a phenol, an amide, a carboxylic acid ester, a phosphinic acid ester, a phosphonic acid ester, and a phenol ether; and
wherein R³ and R⁴ are each selected from one of a hydroxy or an alkoxy group;
adding a base to the first solution to obtain a second solution, wherein the base deprotonates the compound;
introducing an insoluble rare-earth metal composition to the second solution to obtain a mixture, the rare-earth metal composition including a plurality of rare-earth metal components;
agitating the mixture for a period of time, wherein the compound is a leaching agent that forms a metal-ion complex with a component of the rare-earth metal composition based on size, the metal-ion complex being dissolved in the solvent whereby the compound dissolves the otherwise insoluble rare-earth metal component; and
filtering the mixture to obtain a filtered solid and a supernatant;
wherein the metal-ion complex is present in the supernatant.

16. The method of claim 15, wherein the solvent is water.

17. The method of claim 15, wherein the base is NaOH.

18. The method of claim 15, further including the step of adding a buffer to the second solution.

19. The method of claim 15, wherein the pH of the solution is in a range of from 7 to 10.

20. The method of claim 15, wherein the rare-earth metal composition includes a rare-earth metal hydroxide or rare-earth metal oxide.

21. The method of claim 15, wherein the compound is reverse-size selective such that more large rare-earth elements (LREE) are present in the supernatant in comparison to small rare-earth elements (HREE).

22. The method of claim 15, including the step of disassociating the rare-earth element from the compound in the supernatant to strip the rare-earth element from the compound.

23. The method of claim 22, wherein the step of disassociating the rare-earth element includes introducing oxalic acid to precipitate the rare-earth element as a rare-earth element oxalate, and subsequent filtration to separate the compound from the rare-earth element oxalate.

24. The method of claim 23, including the step of adjusting the pH of the compound.
